(19) United States
(12) Patent Application Publication
(10) Pub. No.: US 2004/0032741 A1
(43) Pub. Date: Feb. 19, 2004

(54) Lamp reel

(76) Inventor: Chan-Chuan Tai, Changhua City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,931

(22) Filed: Aug. 13, 2002

(51) Int. Cl. F21V 27/00

(52) U.S. Cl. 362/387; 362/157; 362/258

(57) ABSTRACT

A lamp reel is disclosed to include a housing, a spring-controlled reversible reel pivoted to the inside of the housing and rotated to wind up/let off a flexible tube, which holds a power cord on the inside and a lamp at one end outside the housing, and a clip adapted for securing the housing to the user's waist belt.

### BACKGROUND OF THE INVENTION

1. Field of the Invention

The present invention relates to a hand lamp and, more particularly, to a lamp reel that can be conveniently carried by the use and operated to extend the lamp to the desired distance and angle to illuminate a particular narrow space.

2. Description of the Related Art

When using a portable lamp during the work, for example, a flashlight or work lamp, the user must hold the lamp with one hand and move it to the desired place and direction to illuminate a particular spot. It is inconvenient to hold a lamp with one hand when working. Further, the user may be not able to insert the lamp into a gap in the work place to illuminate a particular spot.

### SUMMARY OF THE INVENTION

The present invention has been accomplished under the circumstances in view. It is one object of the present invention to provide a lamp reel that enables the user to extend to the lamp to the desired distance and angle to illuminate a particular spot when working. It is another object of the present invention to provide a lamp reel, which is auto reversible. It is still another object of the present invention to provide a lamp reel, which can be carried on the body of the user to illuminate a particular spot, leaving the user's both hands free for working. To achieve these and other objects of the present invention, the lamp reel comprises a housing, the housing having an outlet; a reel pivoted to the inside of the housing, the reel comprising an endless peripheral groove extended around the periphery thereof, a first receiving chamber, and a second receiving chamber; a battery mounted in the second receiving chamber inside the housing; a flexible tube wound round the endless peripheral groove of the reel, the flexible tube having a first end fastened to a part inside the housing and a second end extended out of the housing through the outlet; a spring member mounted in the second receiving chamber of the reel and adapted for imparting a rotary driving force to the reel, the spring member having one end fixedly fastened to the housing and an opposite end fixedly fastened to the reel; a lamp fixedly fastened to the second end of the flexible tube and disposed outside the housing; a power cord inserted through the flexible tube and electrically connected between the lamp and the battery; a power switch adapted for controlling on/off status of the lamp; and a clip adapted for securing the housing to the user's body belt.

### BRIEF DESCRIPTION OF THE DRAWINGS

FIG. 1 is an exploded view of a lamp reel according to the first embodiment of the present invention.

FIG. 2 is another exploded view of the lamp reel according to the first embodiment of the present invention when viewed from another side.

FIG. 3 is a schematic drawing of the lamp reel according to the first embodiment of the present invention, showing flexible tube moved in and out of the outlet of the housing and bent in one direction.

FIG. 4 is a sectional view of the lamp reel according to the first embodiment of the present invention.

FIG. 5 is schematic drawing showing the pawl member moved relative to the ratchets of the reel according to the first embodiment of the present invention.

FIG. 6 is a schematic drawing showing the use of a clip with the lamp reel according to the first embodiment of the present invention.

FIG. 7 is a schematic drawing showing a rack with a mirror holder installed in the flexible tube according to the present invention.

FIG. 8 is a schematic drawing showing a rack with a magnet installed in the flexible tube according to the present invention.

FIG. 9 illustrates a constructed according to the second embodiment of the present invention.

FIG. 10 is a sectional view of the lamp reel according to the second embodiment of the present invention.

FIG. 11 is a schematic drawing showing the use of a clip with the lamp reel according to the second embodiment of the present invention.

### DETAILED DESCRIPTION OF THE PREFERRED EMBODIMENT

Referring to FIGS. from 1 through 4, a lamp reel 1 in accordance with the first embodiment of the present invention is shown comprising a housing 11, a reel 114 pivotally mounted inside the housing 11, a flexible tube 115 wound round the endless peripheral groove 1141 of the reel 114, and a lamp 116 fixedly fastened to one end of the flexible tube 115 and disposed outside the housing 11.

The housing 11 has an outlet 111 through which one end, namely, the outer end of the flexible tube 115 extends to the outside of the housing 11, and a sliding way 1111 disposed adjacent to the outlet 111. The outlet 111 is smaller than the diameter of the lamp 116 so that the lamp 116 is stopped outside the outlet 111 of the housing 11 when the reel 114 rotated to wound up the flexible tube 115. The lamp 116 may be variously embodied. According to this embodiment, the lamp 116 is a high brightness LED (light emitting diode). The reel 14 comprises a first receiving chamber 1142, a second receiving chamber 1143, two ratchets 1148 arranged in parallel at two sides of the peripheral groove 1141, and two ring contacts 1145 concentrically disposed at one side. The first receiving chamber 1142 holds a battery box 1146. The battery box 1146 holds a battery 1147 and a booster circuit 1144 on the inside. The ring contacts 1145 are respectively connected to the positive and negative terminals of the booster circuit 1144. A power switch 117 is mounted in one side of the housing 11 and adapted to control on/off status of the booster circuit 1144, having positive and negative terminals 1171 respectively disposed in contact with the ring contacts 1145. A power cord 1151 is inserted through the flexible tube 115, having one end electrically connected to the (positive and negative terminals of) lamp 116 and the other end electrically connected to the (positive and negative terminals of) booster circuit 1144. A springy pawl member 113 is mounted inside the housing 11, having a hooked portion 1131 protruded from the free end thereof adapted for hooking up with the ratchets 1148 to stop the reel 114 from rotation (see also FIG. 5). A spiral spring 1149 is mounted in the second receiving chamber 1142 of the reel 114, having one end fixedly fastened to the housing 11 and 6the other end fixedly fastened to the reel 114. The spiral spring 1149 holds the reel 14 in such a position that the flexible tube 115 is wound up, keeping the lamp 116 stopped at one side of the outlet 111 outside the housing 11. A lock and automatic rewind switch 112 is mounted in the outside of the housing 1, and moved along the sliding way 1111 between two positions, namely, the locking position and the unlocking position. When switching the lock and automatic rewind switch 112 to the locking position, the pawl member 113 is forced into engagement with the ratchets 114 to stop the reel 114 in position. On the contrary, when switching the lock and automatic rewind switch 112 to the unlocking position, the pawl member 113 is disengaged from the reel 114, enabling the reel 114 to be rotated freely. When the reel 14 released from the constraint of the pawl member 13, the user can than pull the lamp 116 and the flexible tube 115 out of the housing 11 to the desired distance. When pulling the lamp 116 and the flexible tube 115 out of the housing 11, the spiral spring 1149 is wound up to reserve energy. Therefore, when released the lamp 116 and the flexible tube 115 from the hand after the lock and automatic rewind switch 112 has been switched to the unlocking position, the spiral spring 1149 automatically rotates the reel 114 to wind up the flexible tube 15.

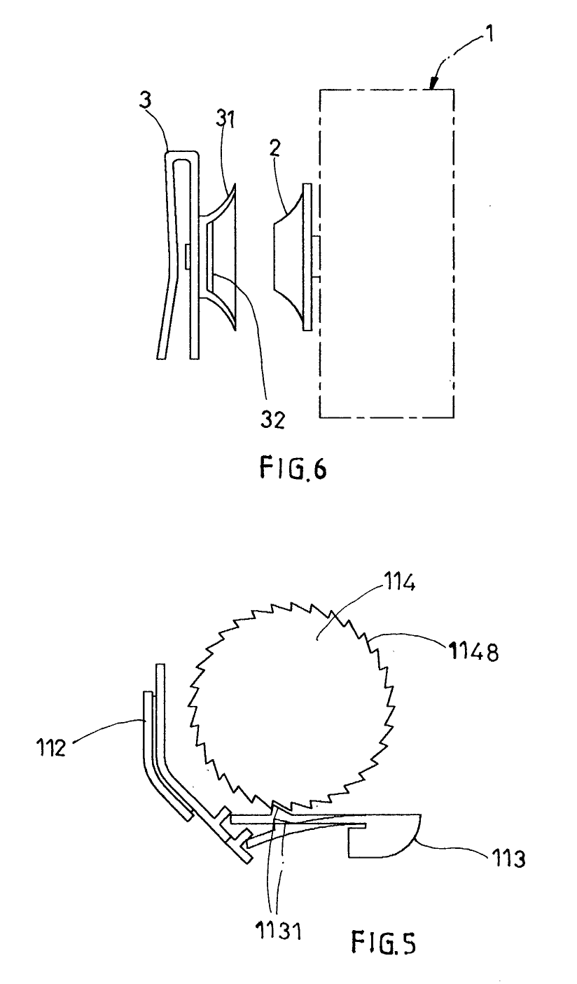

Referring to FIG. 6, the lamp reel 1 further comprises a conical magnet 2 fixedly fastened to the back sidewall of the housing 11. A clip 3 is provided and adapted for securing the lamp reel 1 to the user's body belt. The clip 3 comprises a conical socket 31 fitting the conical magnet 2, and a magnet 32 fixedly mounted in the conical socket 31 and adapted for attracting the conical magnet 2.

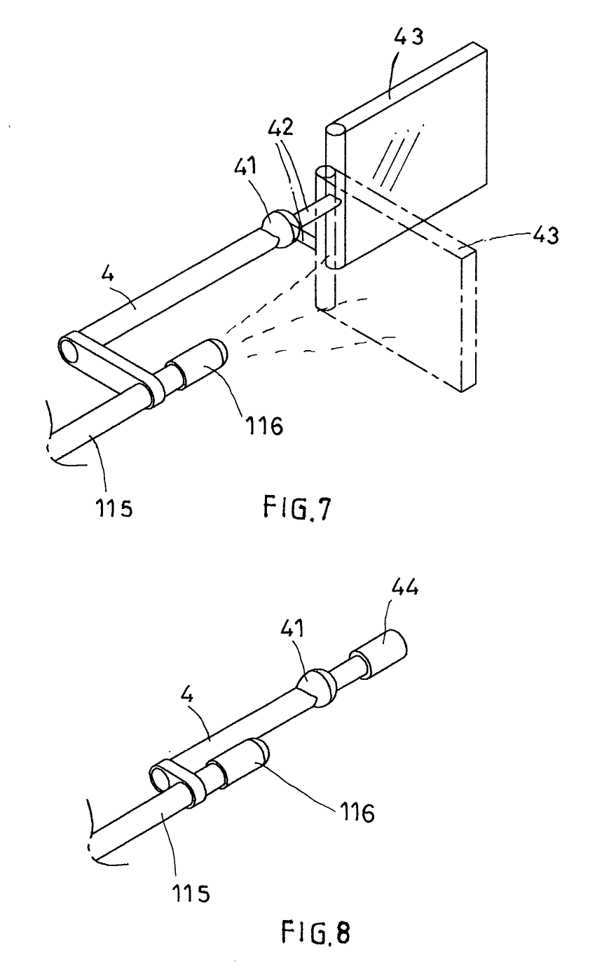

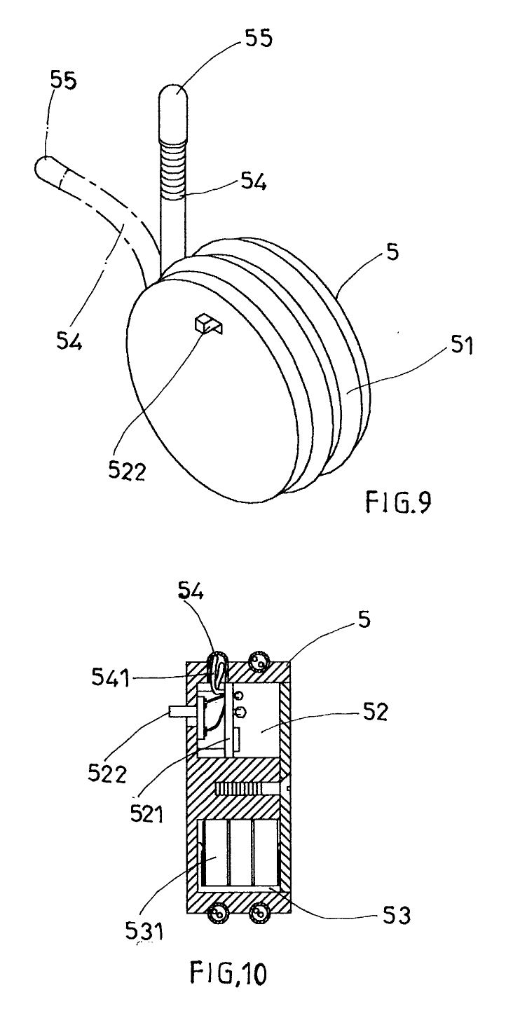

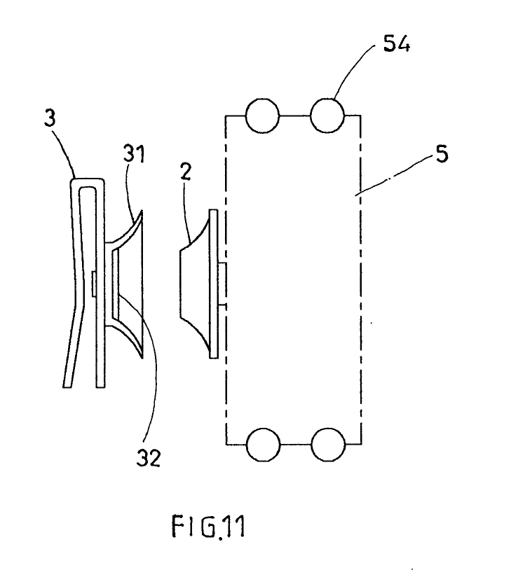

Referring to FIG. 7, a bracket 4 may be used and fixedly fastened to the flexible tube 115 adjacent to the lamp 116, having a universal joint 41 and a mirror holder 42 fastened to the universal joint 41. The mirror holder 42 holds a mirror 43 in front of the lamp 116.

Referring to FIG. 8, a bracket 4 may be used and fixedly fastened to the flexible tube 115 adjacent to the lamp 116, having a universal joint 41 and a magnet 44 fastened to the universal joint 41 and adapted for picking up small ferrous metal items.

FIGS. 9˜11 show a lamp reel constructed according to the second embodiment of the present invention. According to this embodiment, the lamp reel comprises a reel 5, the reel 5 having a first receiving chamber 52 and a second receiving chamber 53, a flexible tube 54 wound round the peripheral groove 51 of the reel 5, the flexible tube 54 having an inner end fastened to the inside of the reel 5 and an outer end mounted with a lamp 55, a booster circuit 521 mounted in the first receiving chamber 52, a battery 531 mounted in the second receiving chamber 53 and electrically connected to the booster circuit 521, a power switch 522 mounted in one side of the reel 5 and adapted for controlling on/off status of the booster circuit 521, a power cord 541 inserted through the flexible tube 54 and electrically connected between the lamp 55 and the booster circuit 521, a conical magnet 2 fixedly fastened to the back sidewall of the reel 5, and a clip 3 adapted for securing the reel 5 to the user's body belt. The clip 3 comprises a conical socket 31 fitting the conical magnet 2, and a magnet 32 fixedly mounted in the conical socket 31 and adapted for attracting the conical magnet 2.

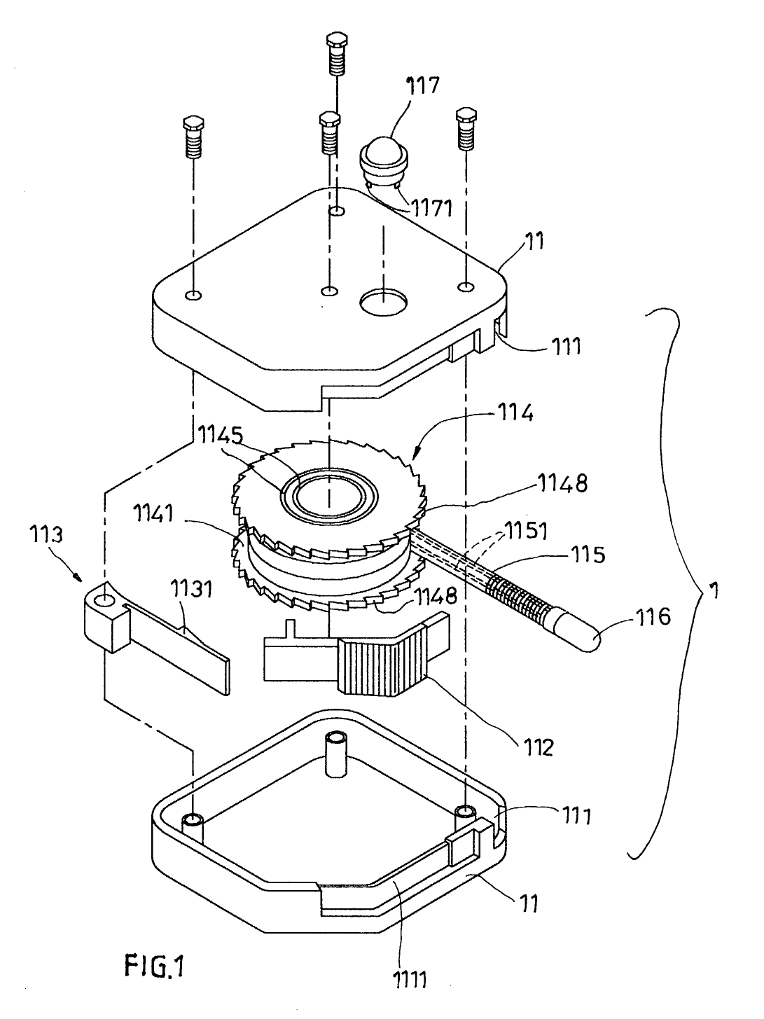

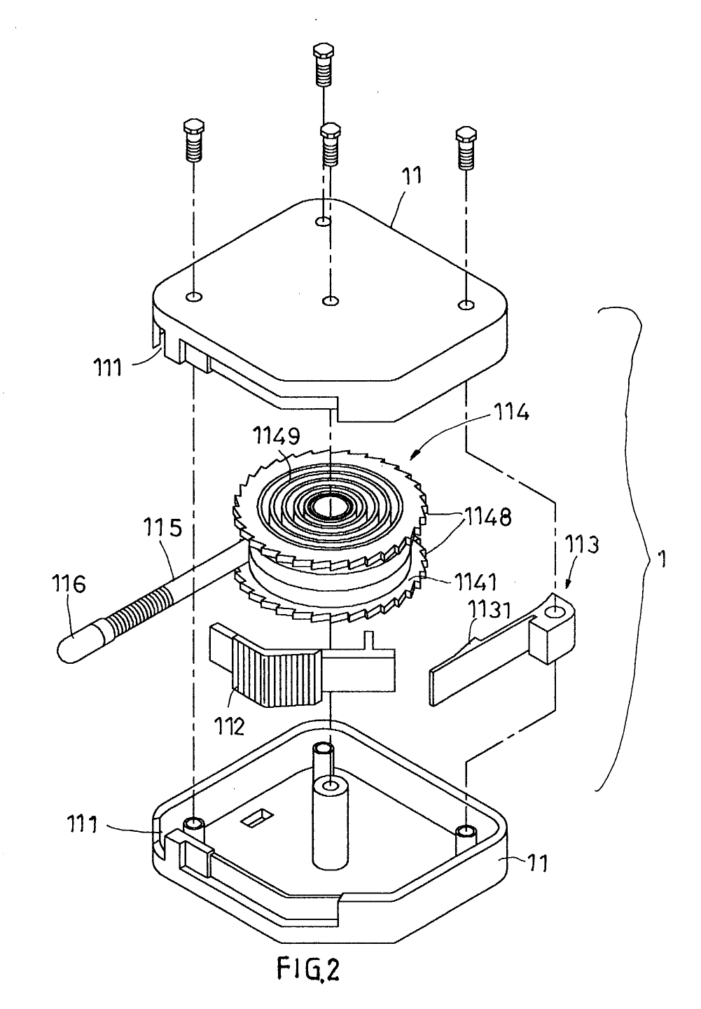

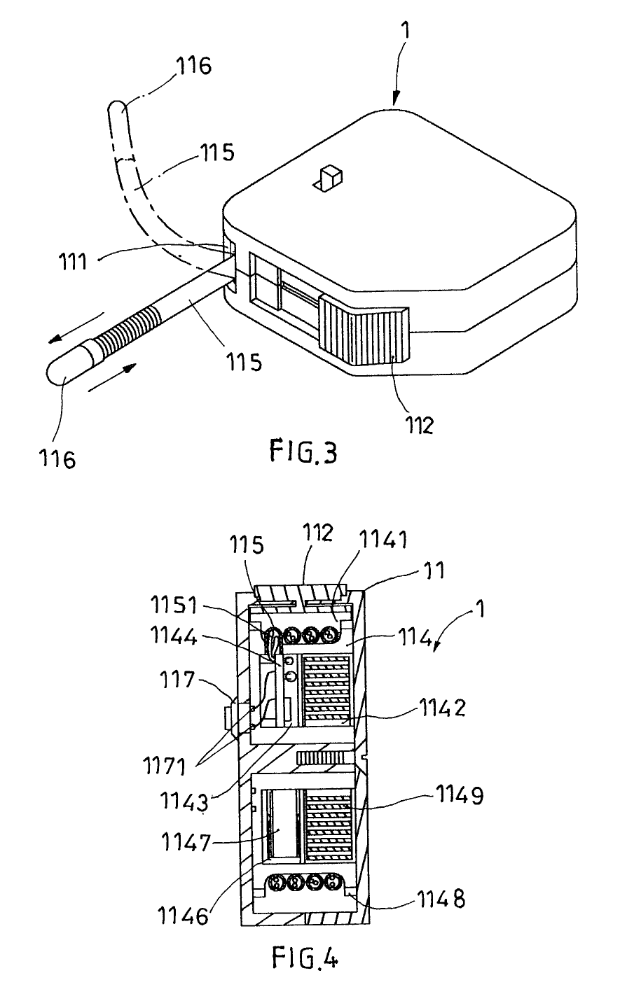

A prototype of auto-reversible lamp reel has been constructed with the features of FIGS. 1˜11. The lamp reel functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A lamp reel comprising:
a housing, said housing having an outlet;
a reel pivoted to the inside of said housing, said reel comprising an endless peripheral groove extended around the periphery thereof, a first receiving chamber, and a second receiving chamber;
a battery mounted in said second receiving chamber inside said housing;
a flexible tube wound round said endless peripheral groove of said reel, said flexible tube having a first end fastened to a part inside said housing and a second end extended out of said housing through said outlet;
a spring member mounted in said second receiving chamber of said reel and adapted for imparting a rotary driving force to said reel, said spring member having one end fixedly fastened to said housing and an opposite end fixedly fastened to said reel;
a lamp fixedly fastened to the second end of said flexible tube and disposed outside said housing;
a power cord inserted through said flexible tube and electrically connected between said lamp and said battery; and
a power switch adapted for controlling on/off status of said lamp.

2. The lamp reel as claimed in claim 1 further comprising a booster circuit mounted in said first receiving chamber of said reel and electrically connected between said battery and said lamp and adapted for boosting the voltage of battery power of said battery.

3. The lamp reel as claimed in claim 2, wherein said reel comprises two ring contacts concentrically disposed at one side thereof and respectively connected to positive and negative terminals of said booster circuit; said power switch comprises a positive terminal and a negative terminal respectively disposed in contact with said ring contacts.

4. The lamp reel as claimed in claim 1, further comprising two ratchets fixedly arranged in parallel at two sides of said reel, a pawl member mounted inside said housing and adapted for engaging said ratchets to stop said reel from rotary motion relative to said housing, and a lock and automatic rewind switch mounted in said housing on the outside and moved along the sliding way between a first position where said lock and automatic rewind switch forces said pawl member into engagement with said ratchets to stop said reel from rotary motion relative to said housing and a second position where said lock and automatic rewind switch releases said pawl member from said ratchets for enabling said reel to be biased by said spring member.

5. The lamp reel as claimed in claim 1 further comprising a first magnet fixedly fastened to an outside wall of said housing, a clip adapted for securing said housing to an external support means, said clip comprising a socket adapted for receiving said first magnet, and a second magnet fixedly fastened to an inside wall of said socket and adapted for attracting said first magnet.

6. The lamp reel as claimed in claim 1 further comprising a bracket fastened to said flexible tube adjacent to said lamp, said bracket comprising a front universal joint and a lamp holder fastened to said front universal joint and holding a mirror in front of said lamp.

7. The lamp reel as claimed in claim 1 further comprising a bracket fastened to said flexible tube adjacent to said lamp, said bracket comprising a front universal joint and a magnet fastened to said front universal joint and adapted for picking up small ferrous metal items by means of magnetic attraction.

8. A lamp reel comprising:
a reel, said reel comprising an endless peripheral groove, a first receiving chamber, and a second receiving chamber;
a booster circuit mounted in said first receiving chamber inside said reel;
a battery mounted in said second receiving chamber inside said reel and electrically connected to said booster circuit;
a flexible tube wound round said endless peripheral groove of said reel, said flexible tube having a first end fixedly fastened to a part inside said reel and a second end exposed to the outside of said reel;
a lamp fixedly mounted on the second end of said flexible tube;
a power cord inserted through said flexible tube and electrically connected between said lamp and said booster circuit; and
a power switch adapted for controlling on/off status of said lamp.

9. The lamp reel as claimed in claim 8 further comprising a first magnet fixedly fastened to an outside wall of said reel, a clip adapted for securing said reel to an external support means, said clip comprising a socket adapted for receiving said first magnet, and a second magnet fixedly fastened to an inside wall of said socket and adapted for attracting said first magnet.
